(19) United States
(12) Patent Application Publication
(10) Pub. No.: US 2025/0376011 A1
(43) Pub. Date: Dec. 11, 2025

(54) Screen Assembly For Vehicle Window

(71) Applicant: Luno Inc., Bend, OR (US)

(72) Inventors: Peter Ducato, Bend, OR (US); Landon Lang Burnley, Bend, OR (US); Ramsey Lang Carter, Bend, OR (US)

(73) Assignee: Luno Inc., Bend, OR (US)

(21) Appl. No.: 18/737,428

(22) Filed: Jun. 7, 2024

(51) Int. Cl. B60J 1/20

(52) U.S. Cl. CPC B60J 1/20

(57) ABSTRACT

A screen assembly for a vehicle window on a vehicle door comprising a screen unit having a panel and a perimeter, the screen assembly having a plurality of magnets dispersed along all but one side of the perimeter of the screen assembly for removably securing said screen assembly to a vehicle door, and a plurality of inserts dispersed along the perimeter of the other side of the perimeter for also securing the screen assembly to the window of the vehicle.

### FIELD OF THE INVENTION

The present invention relates generally to a protective screen assembly for a vehicle window on a vehicle door. The screen assembly includes a screen unit with a panel and a perimeter, the perimeter provided with a dual fastening mechanism for securing the screen assembly to the vehicle, the dual fastening mechanism including 1) a plurality of magnets dispersed along all but one side of the perimeter of the screen assembly for removably securing said screen assembly to a vehicle door over a window space, and 2) a plurality of inserts dispersed along the perimeter of a single side of the perimeter of the for sliding the side securely into a window seal in the window of the vehicle.

### BACKGROUND OF THE INVENTION

Outdoor enthusiasts frequently steep or spend extended periods of time in and around their vehicles to enjoy being in nature. During the summer, warm temperatures require a window or windows of the vehicle to be down to keep the vehicle comfortable. However, rolled down windows introduce a different nuisance in the form of invading insects and arachnids that can enter the vehicle interior. Several different types of vehicle window covering devices are known in the prior art, including devices useful as sunshades and insect screens.

For example, U.S. Pat. No. 3,670,798 to Hess and WO 2024/031171 to Martin disclose a screen for an open vehicle window made from a netting or mesh. The screen of both Hess and Martin can be attached over a car window of a side door using magnetic means disposed within or on the bottom perimeter of the screen. Additionally, a drawstring is provided inside the entire border of the screen to tighten the screen against the interior and exterior surfaces of the door. The screen described above is limited in its use to side door windows and can not be employed for roll-down back windows, as those found in many sport utility vehicles (SUVs).

Hess also describes an embodiment of a vehicle screen in which a flexible rubberized magnet means is secured to the screen border to facilitate the attachment of the screen to the vehicle. The screen is larger than the window which it covers so that the magnet means can be brought into contact with the metal surface of the vehicle extending around the window. While the rubberized magnet provides for some protection from the environment, the ingress of insects is not entirely prevented. Alternatively, the rubberized magnet means can be replaced with a plurality of nut-and-bolt fasteners or a drawstring secured to hooks. However, both of the aforementioned embodiments require at least a portion of the fastener to be mounted to the vehicle.

There therefore still exits a need for providing a removable screen that substantially prevents ingress of insects and arachnids through an open car window. The screen is configured to fit over a side vehicle window or a roll-down rear vehicle window and enables a user with quick and easy installation and removal. The screen additionally provides ample airflow from the outside to the interior of the car door while blocking out undesirable elements of nature such as rain and sunlight. Accordingly, a removable, protective screen assembly including a screen unit having a panel and a perimeter is disclosed herein for use over a vehicle window. The screen assembly includes a dual fastening mechanism for removably securing the screen to the vehicle door and the vehicle window, thereby preventing the ingress of pests into the interior of the vehicle.

### SUMMARY OF THE INVENTION

In light of the foregoing, it is an object of the present invention to provide a screen assembly for use with a vehicle having side windows and/or a roll-down rear window, the screen assembly including a screen unit having a panel made from a first material and a perimeter made from a second material, wherein the panel is positioned on an inside of the perimeter and the perimeter has at least a top side, a bottom side, a left side and a right side. The screen assembly additionally includes a dual fastening mechanism: 1) a plurality of magnets fixed inside the perimeter of at least the bottom side, the left side and the right side of said perimeter; and 2) a plurality of inserts made from a third material and fixed inside or on the perimeter of a single side thereof. The plurality of magnets function to magnetically secure the screen assembly to the vehicle door to at least the bottom side, the left side and the right side of the perimeter of the screen unit. The plurality of inserts fixed inside the perimeter at the top side slide into a weather seal in the window of the vehicle to secure the screen assembly to the vehicle at the top side of the perimeter of the screen unit. It will be understood by those skilled in the art that one or more aspects of this invention can meet certain objectives, while one or more other aspects can meet certain other objectives. Each objective may not apply equally, in all its respects, to every aspect of this invention. As such, the following objects can be viewed in the alternative with respect to any one aspect of this invention.

Accordingly, it can also be an object of the present invention to provide a method for installing a screen assembly for use with a vehicle having side windows and/or a roll-down rear window, the screen assembly including a screen unit having a panel made from a first material and a perimeter made from a second material, wherein the panel is positioned on an inside of the perimeter and the perimeter has at least a top side, a bottom side, a left side and a right side. The screen assembly additionally includes a dual fastening mechanism: 1) a plurality of magnets fixed inside the perimeter of at least the bottom side, the left side and the right side of said perimeter; and 2) a plurality of inserts made from a third material and fixed inside the perimeter of a single side thereof. The plurality of magnets function to magnetically secure the screen assembly to the vehicle door to at least the bottom side, the left side and the right side of the perimeter of the screen unit. The plurality of inserts fixed inside the perimeter at the top side slide into a weather seal in the window of the vehicle to secure the screen assembly to the vehicle at the top side of the perimeter of the screen unit.

As provided herein, the method of installing the screen assembly includes the steps of 1) securing the sides of the perimeter with the plurality of magnets to a vehicle door, 2) pushing or sliding the inserts on or in the side of the perimeter into a window seal, and 3) pulling the sides of the perimeter with the plurality of magnets distally to tighten the screen assembly over the window to assure prevention of ingress of pests.

Other objects, features, benefits and advantages of the present invention will be apparent from this summary and the following descriptions of certain embodiments and will be readily apparent to those skilled in the art having knowledge of removable screen assemblies for vehicles. Such objects, features, benefits and advantages will be apparent from the above as taken into conjunction with the accompanying examples, figures and all reasonable inferences to be drawn therefrom. The disclosures in this application of all articles and references, including patents, are incorporated herein by reference.

### BRIEF DESCRIPTION OF THE DRAWINGS

FIG. 1 is a left-front perspective view of a screen assembly as disclosed herein as assembled on a roll-down rear window of a vehicle.

FIG. 2 is a right-front perspective view of the screen assembly of FIG. 1.

FIG. 3 is front view of the screen assembly of FIG. 1.

FIG. 4 is a front view of the screen assembly of FIG. 1 assembled on a roll-down rear window of a vehicle.

FIG. 5 is perspective view of a partially installed screen assembly in a roll-down rear window of a vehicle.

FIG. 6 is perspective view of a user installing a screen assembly in a roll-down rear window of a vehicle.

### DETAILED DESCRIPTION OF INVENTION

As it relates to certain non-limiting embodiments, the present invention relates to a removable, protective screen assembly for use with a vehicle having roll-down windows. The screen assembly as described herein includes a screen unit having a panel and a perimeter, the panel positioned on an inside of the perimeter. The screen assembly further comprises a plurality of magnets fixed inside the perimeter for removably securing the screen assembly to a vehicle door, and a plurality of inserts fixed inside a side of the perimeter of a single side for removably securing the screen assembly to a vehicle window of the vehicle door. The screen assembly of the instant invention is an improvement over the prior art in that it can be made to protect any vehicle window, including vehicles having a rear roll-down window, such as SUVs, jeeps, crossovers, mini-vans and the like. The screen assembly of the present invention also prevents the ingress of pests, such as for example insects and arachnids, and it enables quick and easy installation and removal of the same. Accordingly, the following presents non-limiting examples of an embodiment for a removable screen assembly to protect an open vehicle window. It is to be understood that while terms such as “left”, “right”, “top”, “bottom”, “front”, “back”, “side”, “rear”, and the like may be used in this specification to describe various example features and elements of the invention, these terms are used herein as a matter of convenience, e.g., based on the example orientations shown in the figures or the orientation during typical use.

According to one feature of the illustrated embodiments discussed in detail below, the screen assembly as described herein is manufactured to fit a specific vehicle window. The shape of the screen assembly is therefore configured to accommodate said vehicle window. For example, the shape of the screen assembly can be rectangular, hexagonal or octagonal and include sides that are equal or unequal. Thus, the shape of the screen assembly is either regular or irregular. By “irregular” shape is meant a shape which has sides and angles of different lengths and sizes, i.e. the sides are not all of equal length and the interior angles are not all the same size.

According to another feature of the illustrated embodiments, the panel of the screen unit is made from a first material, the perimeter of the screen unit is made from a second material, and the inserts of the screen assembly are made from a third material. One or more of the first, second and third materials can be the same or all three can be made from different material. For example, the first material is made from a wide range of materials, including but not limited to, a polymer and a cloth, and preferably a flexible, dark semi-permeable mesh to allow airflow, to restrict sunlight and to impede ingress of pests such as insects and arachnids into the vehicle. The first material includes, for example, fiberglass, vinyl, nylon and the like. The second material is made from a flexible, durable material, such as for example, a durable woven fabric including but not limited to a polyester, a polypropylene and a nylon. The second material is sewn or adhered to the outer edges of the first material, i.e. the panel, and is flexible and durable enough to be folded and sewn or adhered such that it houses the magnets and inserts. The third material, i.e. that of the inserts, is made from a soft but durable material, such as for example, a foam or a rubber, including but not limited to solid polymer foams that include polyurethane foams and the like. The inserts are made to fit in a portion of the window, preferably between the rubber defining a window seal, to removably secure the screen assembly to the vehicle window when the window is an open position.

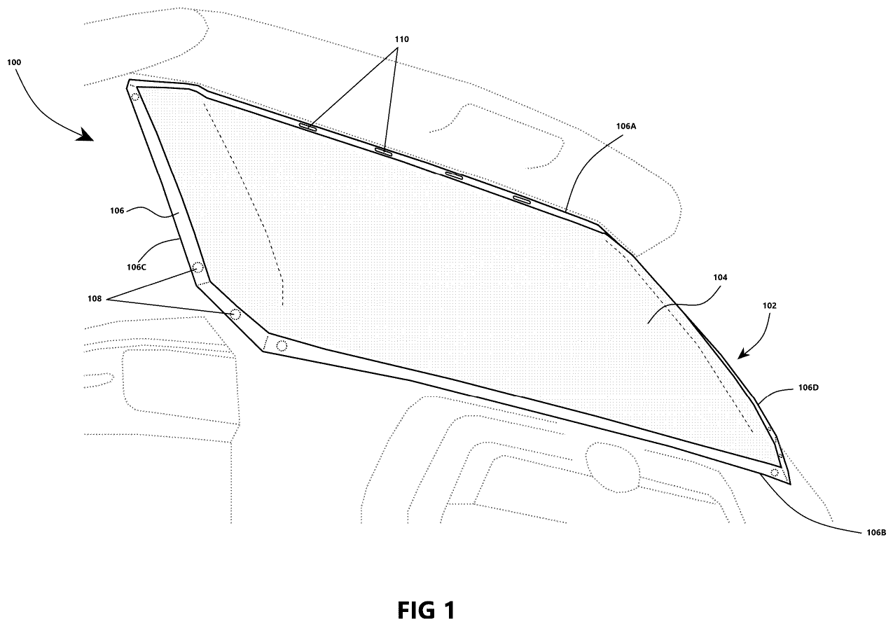

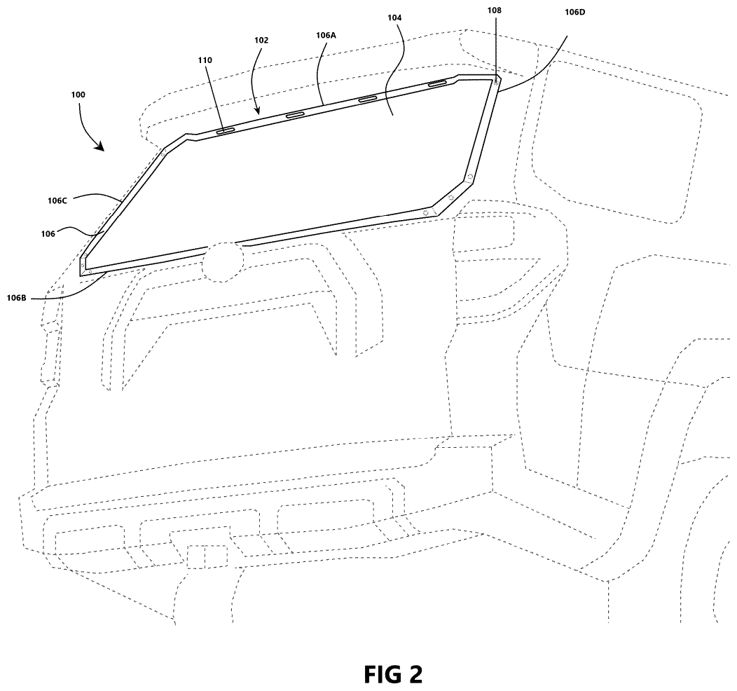

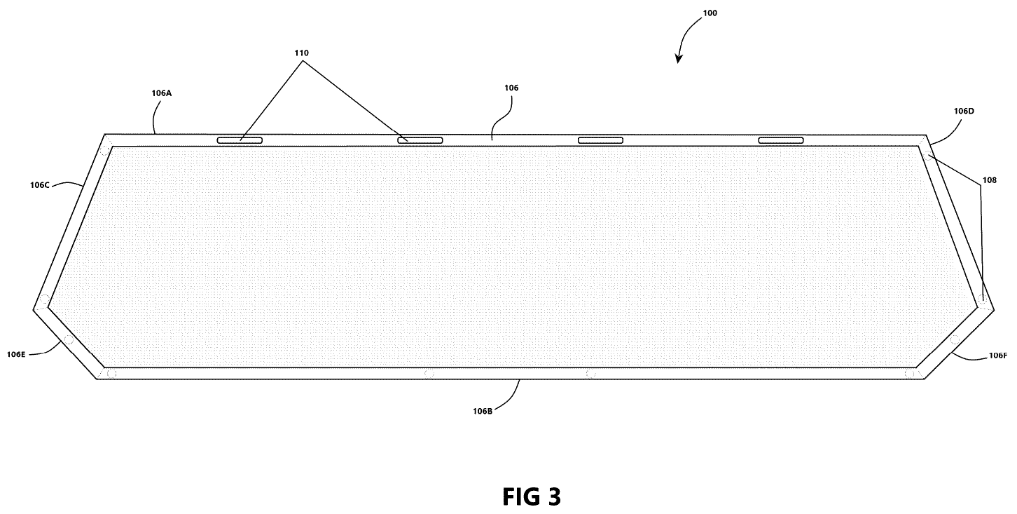

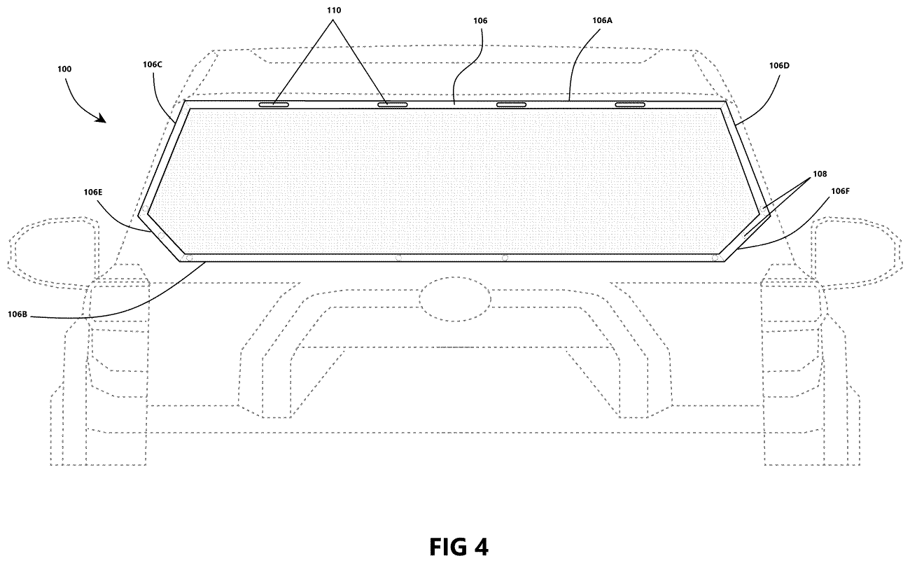

Referring to the specific non-limiting embodiments depicted in FIGS. 1-6, screen assembly 100 is used to protect and cover a roll-down rear window. As shown in FIG. 1 and FIG. 2, depicting a left-front perspective view and a right-front perspective view, respectively, of a screen assembly covering a roll-down rear window of an SUV, screen assembly 100 includes a screen unit 102 having a panel 104 and a perimeter 106. The panel 104 is positioned to the inside, or medial with respect to screen assembly 100 as a whole, of the perimeter 106, while the perimeter 106 is positioned laterally. Perimeter has at least a top (or first) perimeter side 106A, a bottom (or second) perimeter side 106B, a left (or third) perimeter side 106C and a right (or fourth) perimeter side 106D. FIG. 3 and FIG. 4 show a front view of screen assembly 100 and a front view of screen assembly 100 covering a roll-down rear window, respectively, and depicting an optional fifth perimeter side 106E and an optional sixth perimeter side 106F to go along with perimeter sides 106A, 106B, 106C and 106D. Fifth perimeter side 106E is positioned between bottom second side 106B and left third side 106C, while sixth perimeter side 106F is positioned between bottom second side 106B and right fourth side 106D. Thus, screen assembly 100 is in the shape of an irregular hexagon such that it configures to the roll-down rear window of the SUV depicted in FIGS. 1-4.

The screen assembly 100 additionally includes a plurality of magnets 108 fixed inside the perimeter 106. By “magnet” as used herein is meant a material (magnetic material), and preferably an object, that produces a magnetic field. A magnet's magnetic moment is a vector that characterizes the magnet's overall magnetic properties. The direction of the magnetic moment of a magnet points from the magnet's south pole to its north pole, and the magnitude relates to how strong and how far apart these poles are. A magnetic material is any material that is capable of being attracted by or acquiring the properties of a magnet to attract magnetic materials. This includes ferromagnets (magnets including iron) as well as non-ferrous magnets. Some examples of magnetic materials are, but are not limited to, neodymium, steel, nickel, cobalt, an aluminum-nickel-cobalt alloy (alnico), an alloy of rare earth metals, and naturally occurring minerals such as lodestone. Because magnets 108 are fixed inside perimeter 106, they are not visible in FIGS. 1-4 and are indicated as broken lines. The plurality of magnets 108 can be fixed or secured inside the perimeter 106 by a variety of means, including but not limited to sewn or adhered into the inside of the perimeter 106. Magnets 108 are secured inside at least the bottom side 106B, the left side 106C and the right side 106D of perimeter 106. With respect to the specific embodiment depicted in FIGS. 1-4, magnets can also be fixed inside optional sides 106E and 106F. The plurality of magnets 108 function to magnetically secure the screen assembly 100 to a vehicle door. Therefore, at least the bottom side 106B, the left side 106C, the right side 106D, and optionally sides 106E, 106F of the perimeter 106 of the screen unit 102 removably secure the screen assembly 100 to a vehicle door.

Finally, as shown in FIGS. 1-4, a plurality of inserts 110 are fixed on the surface of or inside the perimeter 106 of top side 106A. In other words, the inserts 110 are provided on or in the only side 106A of the perimeter 106 that does not house any magnets 108. Rather, the plurality of inserts 110 fixed on or inside the perimeter 106 at top side 106A slide into a portion of a vehicle window, and preferably a weather seal of a window of of a vehicle door, to secure the screen assembly 100 to the vehicle door at the top side 106A of the perimeter 106 of the screen unit 102.

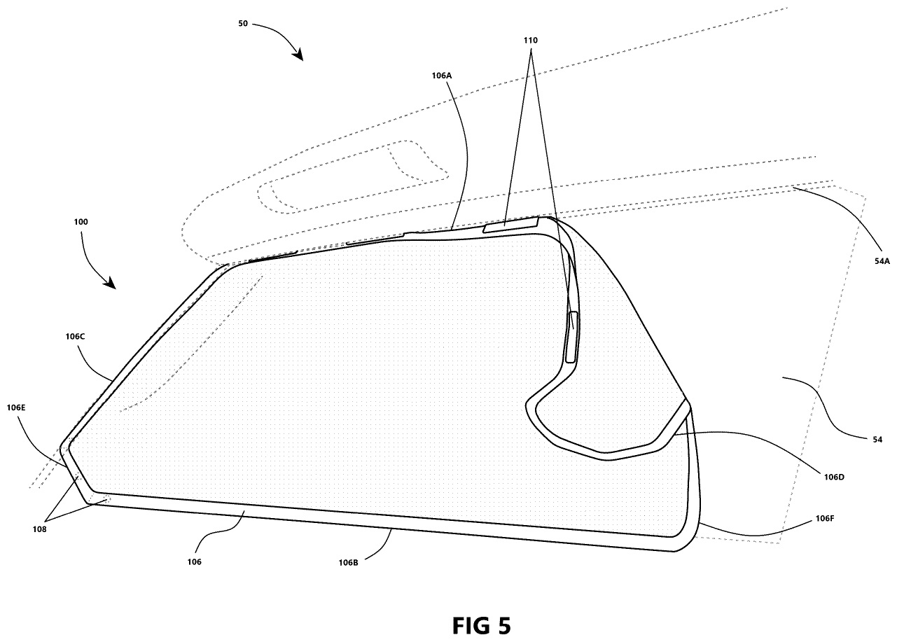

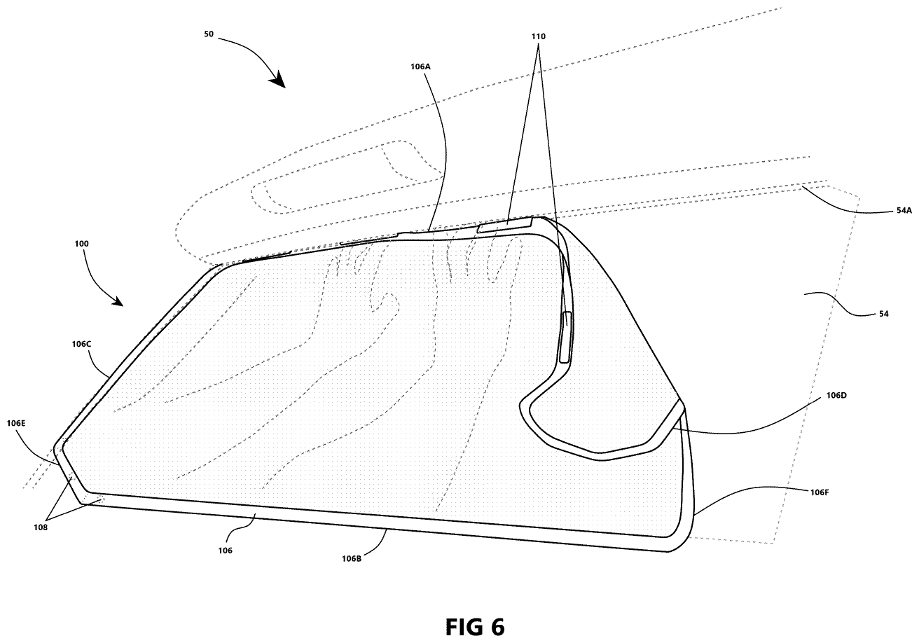

Referring now to FIG. 5, which depicts a perspective view of partially installed screen assembly 100 over a roll-down rear window 54 of a vehicle 50, one half of the perimeter 106, in this case the half representing a portion (approximately half) of side 106B and all of sides 106C and 106E, is initially magnetically secured to vehicle door (not shown). FIG. 6 shows how a user can then begin to push or slide inserts 110 on or in the top side 106A of perimeter 106 closest, or proximal, to side 106C into window seal 54A, which is left vacant because of rear window 54 being in an open position. Inserts 110 are continued to be pushed or slid into window seal 54A in a direction away, or distal, from side 106B until approximately half of screen assembly is removably secured to window 54. The process is then repeated for the other half of the screen assembly 100, i.e. the half represented by the other portion (approximately half) of side 106B and all of sides 106D and 106F. Alternatively, the entire perimeter 106 housing magnets 108 can be removably secured to vehicle door before all inserts 110 on or in side 106A are pushed or slid into window seal 54A. Regardless, once inserts 110 are firmly secured within window seal 54A, one or more of sides 106B, 106C, 106D, 106E and 106F can be pulled distally to tighten screen assembly over window 54 and assure prevention of ingress of pests.

In light of the foregoing, the ease of installation and removal of the screen assembly as described herein is evident. Once removed, the screen assembly can be folded or rolled up further and stored in a carry bag when not in use.

It is therefore an advantage of the screen assembly described herein to provide a dual fastening mechanism comprising magnets and inserts on or in a perimeter of a screen unit to removably secure the assembly to both a vehicle door and the vehicle window found on said door. In particular, the screen assembly described herein cures the deficiencies of the prior art in that it can be used to protect a roll-down rear window of a vehicle, while enabling a user with quick and easy installation and removal. The screen assembly additionally provides ample airflow from the outside to the interior of the car door while blocking out undesirable elements of nature such as rain and sunlight.

Although various embodiments of the screen assembly are illustrated and described herein, it is appreciated that other embodiments are contemplated as being within the scope of the present disclosure and that various substitutions may be made by those skilled in the art without departing from the spirit of the same.

What is claimed is:

1. A screen assembly for covering an open window of a vehicle door, the screen assembly comprising:
a screen unit having a panel made from a first material and a perimeter made from a second material, the panel positioned on an inside of the perimeter and the perimeter comprising at least a top first side, a bottom second side, a left third side and a right fourth side;
a plurality of magnets fixed inside the perimeter at at least the bottom second side, the left third side and the right fourth side; and
a plurality of inserts made from a third material and fixed inside or on the perimeter at the top first side;
the plurality of magnets magnetically securing the screen assembly to the vehicle door at at least the bottom second side, the left third side and the right fourth side of the perimeter of the screen unit; and
the plurality of inserts sliding into a weather seal in the window of the vehicle to secure the screen assembly to the vehicle window at the top first side of the perimeter of the screen unit.

2. The screen assembly of claim 1, wherein the perimeter further comprises a fifth perimeter side positioned between the bottom second side and left third side, and a sixth perimeter side positioned between bottom second side and right fourth side, the screen assembly configured in the shape of an irregular hexagon, and the fifth and sixth sides fixed with a plurality of magnets therein.

3. The screen assembly of claim 2, wherein the plurality of magnets fixed inside the bottom second side, the left third side, the right fourth side, the fifth side and the sixth side magnetically secures the screen assembly to the vehicle door.

4. The screen assembly of claim 1, wherein the first material is a flexible, dark semi-permeable mesh.

5. The screen assembly of claim 4, wherein the first material is a soft nylon fabric.

6. The screen assembly of claim 1, wherein the second material is a durable woven fabric.

7. The screen assembly of claim 1, wherein the third material is a foam.

8. The screen assembly of claim 1, wherein the screen assembly further comprises a carry bag for storing the screen assembly when not in use.

9. The screen assembly of claim 2, wherein the window is a roll-down rear window of the vehicle.

10. The screen assembly of claim 6, wherein the perimeter is sewn or adhered to the the panel.

11. The screen assembly of claim 10, wherein the perimeter is flexible and durable enough to be folded, and sewn or adhered such that the perimeter houses the plurality of magnets and the plurality of inserts.

12. A method of installing the screen assembly of claim 2, comprising the steps of securing the plurality of magnets fixed inside the perimeter at the bottom second side, the left third side, the right fourth side, the fifth perimeter side and the sixth perimeter side to the vehicle door, and pushing or sliding the plurality of inserts on or in the top first side of the perimeter into a window seal to secure the screen assembly to the vehicle window of the vehicle door.

13. The method of installing the screen assembly of claim 12, further comprising the step of pulling the perimeter at the bottom second side, the left third side, the right fourth side, the fifth perimeter side and the sixth perimeter side distally to tighten the screen assembly over the window.
